(19) United States
(12) Patent Application Publication
(10) Pub. No.: US 2024/0134935 A1
(43) Pub. Date: Apr. 25, 2024

(54) METHOD, DEVICE, AND COMPUTER PROGRAM PRODUCT FOR MODEL ARRANGEMENT

(71) Applicant: Dell Products L.P., Round Rock, TX (US)

(72) Inventors: Zijia Wang, WeiFang (CN); Jinpeng Liu, Shanghai (CN); Jiacheng Ni, Shanghai (CN); Zhen Jia, Shanghai (CN)

(21) Appl. No.: 17/985,373

(22) Filed: Nov. 11, 2022

(30) Foreign Application Priority Data
Oct. 20, 2022 (CN) 202211295301.2

(51) Int. Cl. G06K 9/62

(52) U.S. Cl. CPC G06K 9/62

(57) ABSTRACT

Embodiments of the present disclosure relate to a method, a device, and a computer program product for model arrangement. The method includes determining a target model for processing data. The method further includes dividing the target model into a plurality of modules that implement different tasks. The method further includes determining a quantity of parameters of a target module in the plurality of modules and a size of transmission data related to the target module. The method further includes determining an arrangement position of the target module based on the quantity and the size. With this method, the amount of data transmitted can be minimized, and the computing time and the presentation time of information presented to users can be reduced, thereby improving the user experience.

### RELATED APPLICATION

The present application claims priority to Chinese Patent Application No. 202211295301.2, filed Oct. 21, 2022, and entitled “Method, Device, and Computer Program Product for Model Arrangement,” which is incorporated by reference herein in its entirety.

### FIELD

Embodiments of the present disclosure generally relate to the field of data model processing, and specifically, to a method, a device, and a computer program product for model arrangement.

### BACKGROUND

Mixed reality applications, also referred to as MR applications, provide a new barrier-free learning method in education by using an interactive mobile environment. Such implementations are particularly important in the fields of medicine, health education, and the like. In these fields, knowledge acquisition is usually more empirical, autonomous, and practical than in many other disciplines.

Edge computing is a new computing method, in which computing resources are placed at a network edge near users. For an application program (such as a mixed reality application) that is too resource intensive to run on a terminal device but needs an extensively low latency to run in the cloud, edge computing may be used for processing. However, there are still many problems to be solved in the processing of mixed reality applications and other types of applications in the context of edge computing.

### SUMMARY

Embodiments of the present disclosure provide a method, a device, and a computer program product for model arrangement.

According to a first aspect of the present disclosure, a method for model arrangement is provided. The method includes determining a target model for processing data. The method further includes dividing the target model into a plurality of modules that implement different tasks. The method further includes determining a quantity of parameters of a target module in the plurality of modules and a size of transmission data related to the target module. The method further includes determining an arrangement position of the target module based on the quantity and the size.

According to a second aspect of the present disclosure, an electronic device is provided. The electronic device includes at least one processor; and a memory coupled to the at least one processor and having instructions stored thereon, wherein the instructions, when executed by the at least one processor, cause the device to perform actions including: determining a target model for processing data; dividing the target model into a plurality of modules that implement different tasks; determining a quantity of parameters of a target module in the plurality of modules and a size of transmission data related to the target module; and determining an arrangement position of the target module based on the quantity and the size.

According to a third aspect of the present disclosure, a computer program product is provided, which is tangibly stored on a non-transitory computer-readable medium and includes machine-executable instructions, wherein the machine-executable instructions, when executed by a machine, cause the machine to perform steps of the method in the first aspect of the present disclosure.

### BRIEF DESCRIPTION OF THE DRAWINGS

By more detailed description of example embodiments of the present disclosure, provided herein with reference to the accompanying drawings, the above and other objectives, features, and advantages of the present disclosure will become more apparent, where identical reference numerals generally represent identical components in the example embodiments of the present disclosure.

FIG. 1 illustrates a schematic diagram of an example environment in which a device and/or a method according to an embodiment of the present disclosure can be implemented;

FIG. 2 illustrates a schematic diagram of a pipeline of a mixed reality application according to an embodiment of the present disclosure;

FIG. 3 illustrates a schematic diagram of a task allocation architecture according to an embodiment of the present disclosure;

FIG. 4 illustrates a flow chart of a method for model arrangement according to an embodiment of the present disclosure;

FIG. 5 illustrates a schematic diagram of a module in a model according to an embodiment of the present disclosure;

FIG. 6A illustrates a schematic diagram of an example model application scenario according to an embodiment of the present disclosure;

FIG. 6B illustrates a schematic diagram of an example model application scenario according to an embodiment of the present disclosure; and

FIG. 7 illustrates a block diagram of an example device suitable for implementing an embodiment of the present disclosure.

In the drawings, identical or corresponding numerals represent identical or corresponding parts.

### DETAILED DESCRIPTION

Illustrative embodiments of the present disclosure will be described in more detail below with reference to the accompanying drawings. Although the accompanying drawings show some embodiments of the present disclosure, it should be understood that the present disclosure can be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As mentioned above, with the increase of edge computing, many mixed reality applications may be designed to be executed on edge devices. However, for some applications with large amounts of computation and data processing, large quantities of computing resources and storage resources are required. If such applications are arranged on edge devices, due to limited computing resources of the edge devices, the applications may not be able to be processed in sufficient time, which affects the speed of application execution. If the applications are arranged to run on a server side, as the server is far away from users, it takes more time to transmit processing data to the users, thereby affecting the user experience.

In order to at least address the above and other potential problems, embodiments of the present disclosure provide a method for model arrangement. The method first determines a model to be arranged, and then divides the model into a plurality of modules that perform different tasks. Next, the quantity of parameters of each module and the size of transmission data related to each module are determined. Then, based on the quantity of parameters and the size of transmission data, it is determined whether the module is arranged on a server side or at an edge device. In this way, the amount of data transmitted can be minimized, and the computing time and the presentation time of information presented to users can be reduced, thereby improving the user experience.

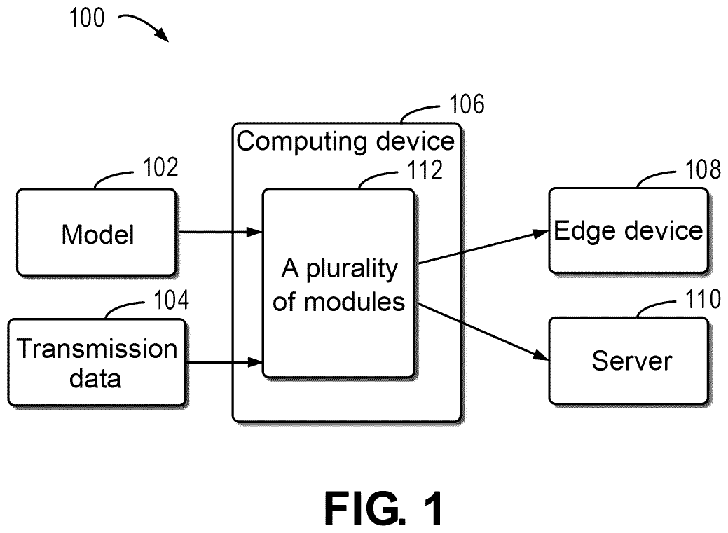

Embodiments of the present disclosure will be further described in detail with reference to the accompanying drawings below. FIG. 1 shows an example environment in which a device and/or a method according to embodiments of the present disclosure can be implemented.

As shown in FIG. 1, example environment 100 includes computing device 106, and computing device 106 may arrange different modules of a model to edge device 108 or server 110. For example, various modules in a mixed reality application model are arranged to edge device 108 or server 110 according to a predetermined rule.

Example computing device 106 includes, but is not limited to, a personal computer, a server computer, a handheld or laptop device, a mobile device (such as a mobile phone, a personal digital assistant (PDA), and a media player), a multi-processor system, a consumer electronic product, a minicomputer, a mainframe computer, a distributed computing environment including any of the above systems or devices, and the like.

Computing device 106 acquires model 102, such as a model for implementing a mixed reality application. Computing device 106 analyzes model 102 to determine a plurality of modules 112 of the model, and each module is used for implementing a sub task of the model. For example, if the model is a voice-based avatar generation model, it may be divided into an audio-based avatar parameter generation module, an avatar video-based avatar parameter generation module, an initial drawing module, and a fine-tuning drawing module. The audio-based avatar parameter generation module is used for generating, through voice, parameters for an avatar, such as an expression and a posture. The avatar video-based avatar parameter generation module is used for determining the brightness, shape, and texture of the avatar based on a video of the avatar. The initial drawing module is used for realizing initial drawing of the avatar based on the expression, posture, brightness, shape, and texture. The fine-tuning drawing module is used for adjusting the avatar. The above four modules are used for realizing conversion from voice to a corresponding video of an avatar.

For the plurality of modules 112 of the model, computing device 106 determines, based on the computing cost and data transmission cost of each module, whether to arrange them on a server or on an edge device connected to the server and close to a user. Specifically, computing device 106 determines, based on the quantity of model parameters in the module and the size of transmission data 104 for the module, whether to arrange it on server 110 or edge device 108.

In the environment 100 of FIG. 1, computing device 106 is illustratively configured to determine an arrangement position of particular ones of the plurality of modules 112 obtained from the model 102, which is only an example and not a specific limitation to the present disclosure. Computing device 106 and edge device 108 may be the same device, or computing device 106 and server 110 may be the same device.

With this method, the amount of data transmitted can be minimized, and the computing time and the presentation time of information presented to users can be reduced, thereby improving the user experience.

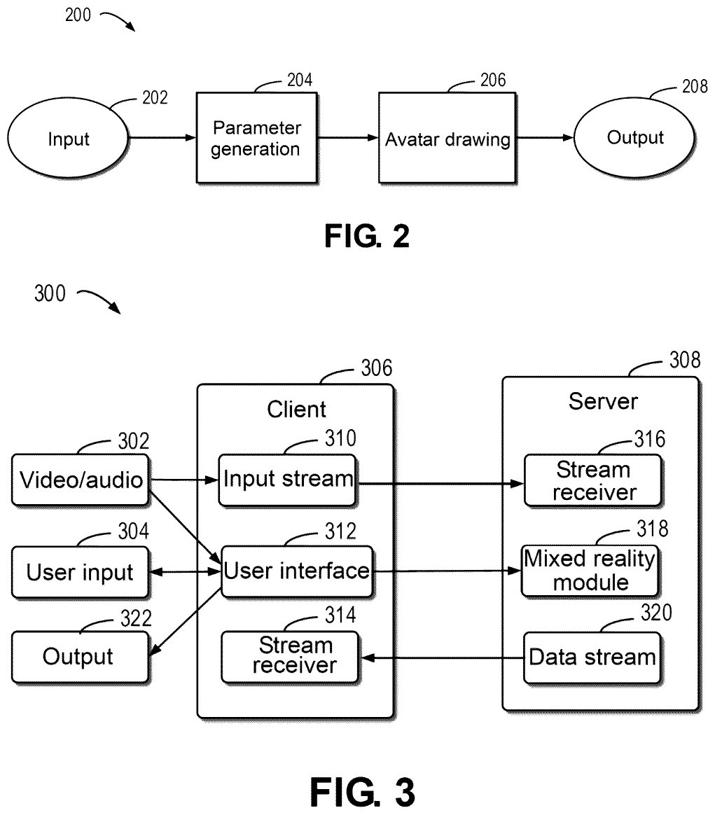

An example environment in which a device and/or a method according to embodiments of the present disclosure can be implemented has been described above with reference to FIG. 1. An example of a mixed reality application is further described below with reference to FIG. 2, and FIG. 2 illustrates a schematic diagram 200 of a pipeline of the mixed reality application according to an embodiment of the present disclosure.

FIG. 2 more particularly shows a pipeline of a mixed reality application for generating an avatar. Data captured by a camera or an audio device is input into the model of the mixed reality application as input 202. Next, at block 204, the inputs are processed by an avatar parameter generation module to generate parameters. Based on the generated parameters, an avatar is drawn by a drawing module at block 206, thereby generating a video of the avatar as output 208. For the mixed reality application for generating the avatar as shown in FIG. 2, the parameter generation and avatar drawing are implemented by modules with relatively large amounts of computation. Therefore, it is necessary to determine arrangement positions of the modules for parameter generation and avatar drawing. Through this method, the particular modules to be arranged may be quickly determined, which improves the accuracy of module arrangement of the model, improves the efficiency of data processing, and saves processing time.

An example pipeline of the mixed reality application according to an embodiment of the present disclosure has been described above with reference to FIG. 2. An architecture for implementing task allocation is further described below with reference to FIG. 3, and FIG. 3 illustrates a schematic diagram 300 of the task allocation architecture according to an embodiment of the present disclosure.

As shown in FIG. 3, when an edge device and a server jointly implement a model, a client and server architecture may be used for achieving task allocation and transmission between the edge device and the server. Client 306 in FIG. 3 is an edge device, and server 308 is a cloud server. For a mixed reality application, the client receives video/audio 302 acquired by a camera or an audio device, and forms input stream 310 in client 306, and then input stream 310 may be transmitted to stream receiver 316 in server 308. The client 306 further includes user interface 312, which may receive video/audio 302, and may further receive user input 304, such as an instruction to add a mixed reality element responsive to a user pressing a screen. Data received by user interface 312 may be transferred to mixed reality module 318 for processing. In server 308, data stream 320 processed by the mixed reality module 318 of the mixed reality application may be transmitted to stream receiver 314 of client 306. Client 306 may then process the received data stream to be presented as output 322 by user interface 312. Based on this architecture, positions of various modules of the mixed reality application may be configured as required to achieve data processing and transmission.

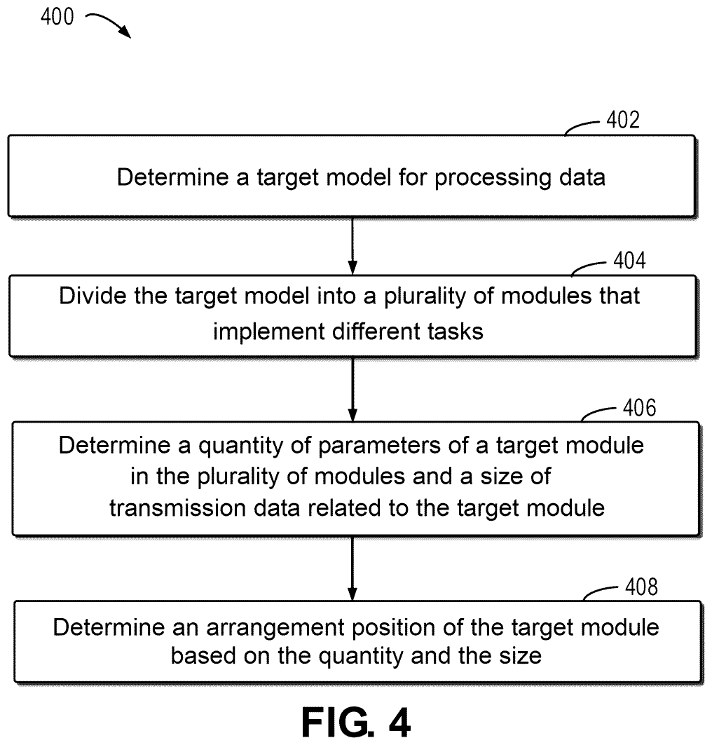

A schematic diagram of the task allocation architecture according to an embodiment of the present disclosure has been described above with reference to FIG. 3. A process of model arrangement is further described below with reference to FIG. 4, and FIG. 4 shows a flow chart of a method 400 for model arrangement according to an embodiment of the present disclosure. The method 400 of FIG. 4 may be performed on computing device 106 in FIG. 1 or any suitable computing device.

As shown in FIG. 4, at block 402, computing device 106 determines a target model for processing data. For example, when a mixed reality application is used, the computing device 106 determines a model of the mixed reality application and determines a model structure.

In some embodiments, the computing device acquires a code of the target model. Then, the computing device analyzes the code of the target model. A group of neural network models in the target model may be determined by analyzing the code. With this method, the computing device can quickly determine the structure of the model.

At block 404, computing device 106 divides the target model into a plurality of modules that implement different tasks. After the structure of the target model is determined, computing device 106 may divide the model into modules that perform different tasks.

In some embodiments, the computing device determines a task of each neural network model in a group of neural network models included in the target model. Then, the neural network models that implement the same task are determined as a module. For example, the task of the neural network model is determined by analyzing an input and an output of the neural network model. In this way, the target model may be divided into modules quickly.

In some embodiments, the computing device divides a code portion of the target model into a plurality of different modules based on description information of the target model. The above examples are intended to describe the present disclosure only and are not specific limitations to the present disclosure.

At block 406, computing device 106 determines the quantity of parameters of a target module in the plurality of modules and the size of transmission data related to the target module. In order to determine the amount of computation and the amount of data transmitted of the target module, it is necessary to determine the quantity of parameters of the target module and the size of the transmitted data.

In some embodiments, the quantity of parameters of the neural network model in the target module is related to the quantity of neurons in the neural network model. Therefore, the computing device may first determine the number of neurons in the target module, and then determine the quantity of parameters based on the number of neurons. Optionally or additionally, the quantity of parameters may be denoted by P, and the unit is thousands of operating parameters. In this way, the quantity of parameters of the target module may be determined quickly and accurately. In addition, the size of the transmission data related to the target module may be denoted by S, and the unit is MegaBytes (MB). In one example, the transmission data is input data of the target module. In another example, the transmission data is output data of the target module. In another example, the transmission data is a sum of input data and output data of the target module. The above examples are intended to describe the present disclosure only and are not specific limitations to the present disclosure.

At block 408, computing device 106 determines the arrangement position of the target module based on the quantity and the size. Computing device 106 uses the quantity of parameters in each target module and the size of the transmission data related to the target module to determine whether to arrange the target module in an edge device or a cloud server.

In some embodiments, when the arrangement position of the target module is determined, the computing device first determines a ratio of the size to the quantity. For example, a value of S/P is determined. If the ratio is greater than a threshold, the target module is arranged in the edge device. If the ratio is less than or equal to the threshold, the target module is arranged in the server. In one example, the threshold is set to 0.8. When the S/P of the target module is >0.8, the target module is arranged in the edge device. When the S/P of the target module is <0.8, the target module is arranged in the server. In another example, the threshold may be set to any suitable value. The above examples are intended to describe the present disclosure only and are not specific limitations to the present disclosure.

With this method, the amount of data transmitted can be minimized, and the computing time and the presentation time of information presented to users can be reduced, thereby improving the user experience.

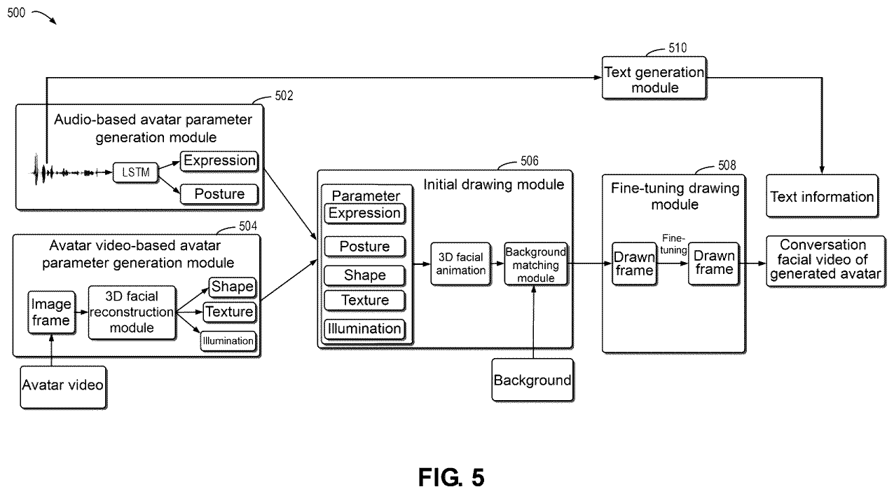

In one example, the model is a voice-based avatar generation model. The voice-based avatar generation model includes an audio-based avatar parameter generation module, an avatar video-based avatar parameter generation module, an initial drawing module, and a fine-tuning drawing module. During module arrangement, the audio-based avatar parameter generation module, the avatar video-based avatar parameter generation module, and the fine-tuning drawing module may be arranged in the server, and the initial drawing module may be arranged in the edge device. The arrangement of the model may be obtained with reference to FIG. 5.

In some embodiments, the computing device receives voice data. Then, the computing device converts the voice data into a video for an avatar through the voice-based avatar generation model. At the same time, the computing device may further generate text information corresponding to the voice data based on the voice data. Then, the video of the avatar and the text information are provided to a display device for display to a user. In this way, voice data of a user may be presented in the form of an avatar, so that information that the user wants to provide may be accurately presented without presenting the user's own information. In one example, when the text information is generated, the computing device first determines a voice feature based on the voice data, such as a Mel-frequency cepstral coefficient (MFCC) feature. Then, the text information is acquired based on the voice feature. In this way, the text information may be accurately acquired.

FIG. 5 illustrates a schematic diagram 500 of module arrangement in a model for presenting a text and a video of an avatar according to an embodiment of the present disclosure. As shown in FIG. 5, the schematic diagram 500 includes a voice-based avatar generation model, which includes audio-based avatar parameter generation module 502, avatar video-based avatar parameter generation module 504, initial drawing module 506, and fine-tuning drawing module 508. In audio-based avatar parameter generation module 502, an input is a voice record collected from a terminal device, and an output is a parameter used for drawing an avatar. In this module, the quantity of parameters related to Long Short-Term Memory (LSTM) is very large, and therefore, its training and reasoning require substantial amounts of computing resources. However, the transmission cost for this module is relatively low. Therefore, an S/P value thereof is small. The module may be arranged in the server. There is very little data to be transmitted, so the transmission cost may be ignored.

Avatar video-based avatar parameter generation module 504 has an input being a video segment larger than an audio segment, but the quantity of model parameters in this module is also very large, so the computing cost is high. Compared with the high computing cost, the transmission cost is relatively low. Therefore, an S/P value thereof is small, so the module is arranged in the cloud server.

In initial drawing module 506, the quantity of model parameters used in the drawing process is not very large, so the computing cost is relatively low. However, the amount of data transmitted for this module is relatively large. Therefore, an S/P value thereof is large. In order to quickly provide the user with a result, it is arranged at an edge node.

Fine-tuning drawing module 508 relies on a very large machine learning model, and has a large quantity of model parameters, resulting in a large amount of computation. Therefore, an S/P value of the module is not as large as that of the initial drawing module 506, so the module 508 is arranged to the cloud server. The fine-tuning result of fine-tuning drawing module 508 will become an improved version of the generated video clip.

The model shown in FIG. 5 further includes text generation module 510, and the module may generate text information by using audio data. Then, the text information and a conversation facial video of the generated avatar are presented together to the user. The text generation module may determine the arrangement position based on the S/P value.

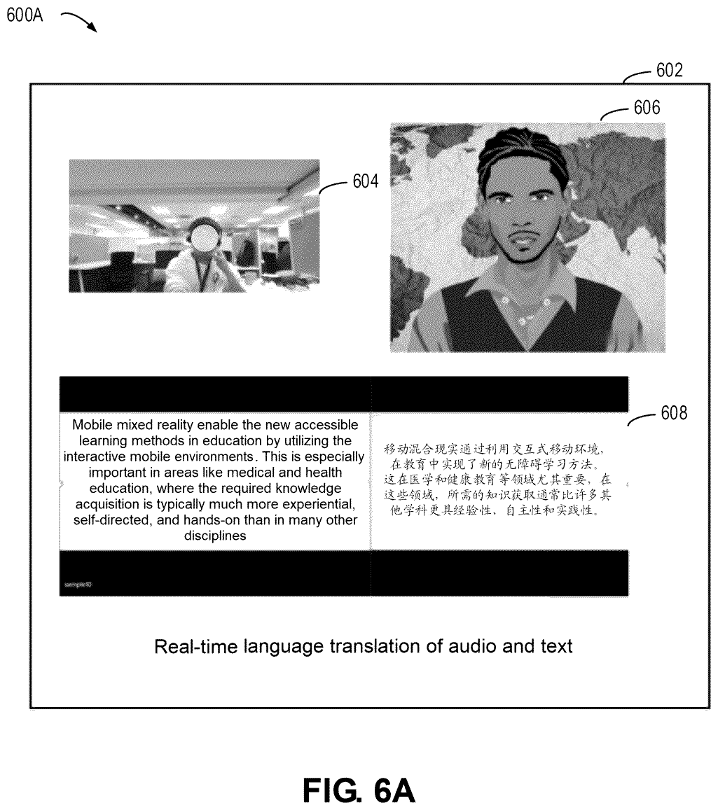

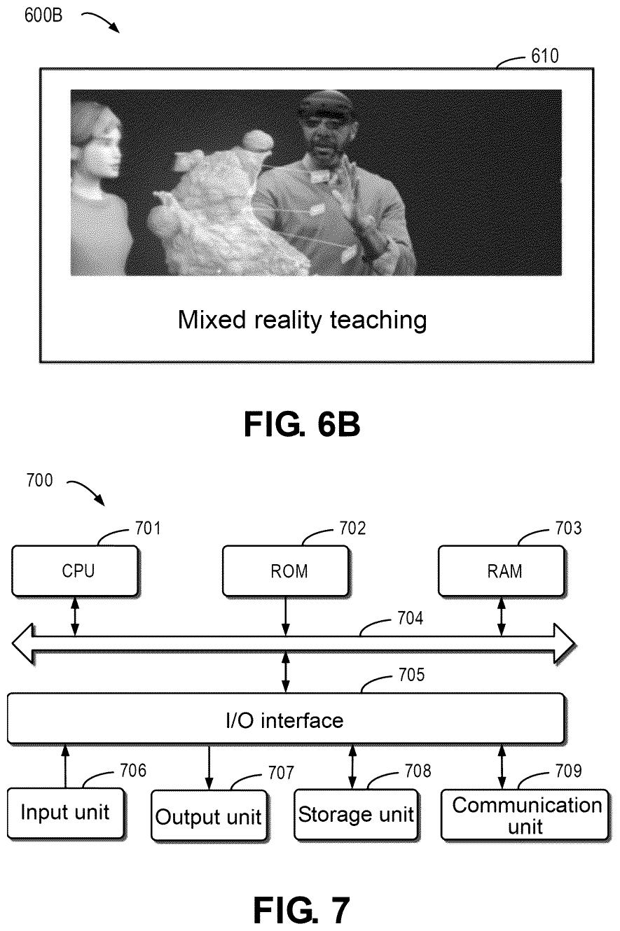

An example arrangement of the modules in the model according to an embodiment of the present disclosure has been described above with reference to FIG. 5. An example of an application scenario of a mixed reality application model will be described below with reference to FIG. 6A and FIG. 6B. FIG. 6A illustrates an example model application scenario 600A according to an embodiment of the present disclosure. FIG. 6B illustrates another example model application scenario 600B according to an embodiment of the present disclosure.

As shown in FIG. 6A, the model of the mixed reality application is applied in a remote conference scenario 602. Video 604 is a user speaking in English, while video 606 is a video of a corresponding avatar presented. Video 606 is presented to users everywhere, and it is not necessary to present video 604 to the users. At the same time, voice of the user may further be converted into a corresponding English text, and the English text may further be translated into a Chinese text for presentation in block 608. The scenario may be implemented by the model in FIG. 5. FIG. 6B shows a scenario of teaching by using an avatar. As shown in block 610, a teaching process of a teacher may be presented through an avatar.

FIG. 7 shows a block diagram of example device 700 that can be used to implement embodiments of the present disclosure. Computing device 106, edge device 108, and server 110 in FIG. 1 and client 306 and server 308 in FIG. 3 may be implemented by using device 700. As shown in the figure, device 700 includes central processing unit (CPU) 701 that may perform various appropriate actions and processing according to computer program instructions stored in read-only memory (ROM) 702 or computer program instructions loaded from storage unit 708 to random access memory (RAM) 703. Various programs and data required for the operation of device 700 may also be stored in RAM 703. CPU 701, ROM 702, and RAM 703 are connected to each other through bus 704. Input/Output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network, such as the Internet, and/or various telecommunication networks.

The various processes and processing procedures described above, such as method 400, may be performed by CPU 701. For example, in some embodiments, method 400 may be implemented as a computer software program that is tangibly included in a machine-readable medium such as the storage unit 708. In some embodiments, part or all of the computer program may be loaded and/or installed onto device 700 via ROM 702 and/or communication unit 709. One or more actions of method 400 described above may be performed when the computer program is loaded into RAM 703 and performed by CPU 701.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated improvements, so as to enable persons of ordinary skill in the art to understand the embodiments disclosed herein.

What is claimed is:

1. A method for model arrangement, comprising:
determining a target model for processing data;
dividing the target model into a plurality of modules that implement different tasks;
determining a quantity of parameters of a target module in the plurality of modules and a size of transmission data related to the target module; and
determining an arrangement position of the target module based on the quantity and the size.

2. The method according to claim 1, wherein determining the target model comprises:
determining a code of the target model; and
determining a group of neural network models in the target model by analyzing the code.

3. The method according to claim 2, wherein dividing the target model into the plurality of modules comprises:
determining a task of each neural network model in the group of neural network models; and
determining neural network models that implement the same task as a module.

4. The method according to claim 1, wherein determining the quantity and the size comprises:
determining the number of neurons in the target module; and
determining the quantity of the parameters based on the number of neurons.

5. The method according to claim 1, wherein determining the arrangement position of the target module comprises:
determining a ratio of the size to the quantity; and
arranging, if the ratio is greater than a threshold, the target module in an edge device.

6. The method according to claim 5, wherein determining the arrangement position of the target module further comprises:
arranging, if the ratio is less than or equal to the threshold, the target module in a server.

7. The method according to claim 6, wherein the target model is a voice-based avatar generation model, and the voice-based avatar generation model comprises an audio-based avatar parameter generation module, an avatar video-based avatar parameter generation module, an initial drawing module, and a fine-tuning drawing module.

8. The method according to claim 7, wherein the audio-based avatar parameter generation module, the avatar video-based avatar parameter generation module, and the fine-tuning drawing module are arranged in the server, and the initial drawing module is arranged in the edge device.

9. The method according to claim 7, further comprising:
receiving voice data;
converting the voice data into a video for an avatar through the voice-based avatar generation model;
generating text information corresponding to the voice data based on the voice data; and
displaying the video of the avatar and the text information.

10. The method according to claim 9, wherein generating the text information comprises:
determining a voice feature based on the voice data; and
acquiring the text information based on the voice feature.

11. An electronic device, comprising:
at least one processor; and
a memory coupled to the at least one processor and having instructions stored therein, wherein the instructions, when executed by the at least one processor, cause the electronic device to perform actions comprising:
determining a target model for processing data;
dividing the target model into a plurality of modules that implement different tasks;
determining a quantity of parameters of a target module in the plurality of modules and a size of transmission data related to the target module; and
determining an arrangement position of the target module based on the quantity and the size.

12. The electronic device according to claim 11, wherein determining the target model comprises:
determining a code of the target model; and
determining a group of neural network models in the target model by analyzing the code.

13. The electronic device according to claim 12, wherein dividing the target model into the plurality of modules comprises:
determining a task of each neural network model in the group of neural network models; and
determining neural network models that implement the same task as a module.

14. The electronic device according to claim 11, wherein determining the quantity and the size comprises:
determining the number of neurons in the target module; and
determining the quantity of the parameters based on the number of neurons.

15. The electronic device according to claim 11, wherein determining the arrangement position of the target module comprises:
determining a ratio of the size to the quantity; and
arranging, if the ratio is greater than a threshold, the target module in an edge device.

16. The electronic device according to claim 15, wherein determining the arrangement position of the target module further comprises:
arranging, if the ratio is less than or equal to the threshold, the target module in a server.

17. The electronic device according to claim 16, wherein the target model is a voice-based avatar generation model, and the voice-based avatar generation model comprises an audio-based avatar parameter generation module, an avatar video-based avatar parameter generation module, an initial drawing module, and a fine-tuning drawing module.

18. The electronic device according to claim 17, wherein the audio-based avatar parameter generation module, the avatar video-based avatar parameter generation module, and the fine-tuning drawing module are arranged in the server, and the initial drawing module is arranged in the edge device.

19. The electronic device according to claim 17, wherein the actions further comprise:
receiving voice data;
converting the voice data into a video for an avatar through the voice-based avatar generation model;
generating text information corresponding to the voice data based on the voice data; and
displaying the video of the avatar and the text information.

20. A computer program product tangibly stored on a non-transitory computer-readable medium and comprising machine-executable instructions, wherein the machine-executable instructions, when executed by a machine, cause the machine to perform a method for model arrangement, the method comprising:
determining a target model for processing data;
dividing the target model into a plurality of modules that implement different tasks;
determining a quantity of parameters of a target module in the plurality of modules and a size of transmission data related to the target module; and
determining an arrangement position of the target module based on the quantity and the size.
